(19) United States
(12) Patent Application Publication
(10) Pub. No.: US 2022/0354230 A1
(43) Pub. Date: Nov. 10, 2022

(54) UNIVERSAL BEACH COOLER AND UMBRELLA HOLDER

(71) Applicant: Jehu Doricent, Margate, FL (US)

(72) Inventor: Jehu Doricent, Margate, FL (US)

(21) Appl. No.: 17/737,685

(22) Filed: May 5, 2022

Related U.S. Application Data
(60) Provisional application No. 63/185,196, filed on May 6, 2021.

(51) Int. Cl. A45C 11/20; A45B 11/00; A45B 3/00

(52) U.S. Cl. CPC A45C 11/20; A45B 11/00; A45B 3/00; B62B 2204/06; A45B 2025/003

(57) ABSTRACT

An adjustable cooler mounted umbrella system, comprising an insulative container defining an internal cavity for reception of contents. The insulative container has an interior surface and an exterior surface. The exterior surface of said insulative container has at least one interface area. Each interface area defines an adjustable mount receiver with a plurality of horizontal recesses. The system includes an umbrella mounting sleeve rotatably coupled to the mount receiver. The umbrella mounting sleeve is configurable for adjustable angulation of an axis of reception of an umbrella shaft. The system includes a locking pin. The locking pin is configured to slide through an aperture in a flange formed on an external surface of the umbrella mounting sleeve and into an interior surface of a horizontal recess of the plurality of horizontal recesses, thereby securing an angulation of the umbrella mounting sleeve relative to the mount receiver.

### CROSS-REFERENCE TO RELATED APPLICATION

This application claims the benefit under 35 USC 119(e) of provisional patent application Ser. No. 63/185,196, filed May 6, 2021, all of which is incorporated by reference in its entirety.

### FIELD OF THE INVENTION

The present invention relates to the broad areas of coolers and umbrella mounts.

### BACKGROUND

The beach is often a very relaxing place to visit the combination of the ocean, beach, park, camping, parties and, so that the sun bring many people out for vacation or just a day out. However, spending too much time outdoors in direct sunlight is not healthy for one's skin, and people who remain out in the sun for long periods of time may develop issues such as sunburn, heat exhaustion and skin cancer risk.

Knowing all of these concerns, many people attempt to stay cool while on the beach by staying in the shade. Traditionally, users attempt to protect themselves from sun exposure by mounting umbrellas or in the sand, which consist of a canopy that is mounted on an upstanding pole. Umbrellas with poles have been modified for insertion into the sand, whereby the pole includes a hollow or a pointed end or stake. Moreover, some of these umbrellas facilitate an angling of the canopy to provide shade during the changing sun positioning. However non-pointed end stakes may also be used.

While traditional umbrellas are suitable during situations where there are not many disturbances to the beach sand, they have limitations when used in windy weather and in unsupportive sand. In these situations, the umbrella can easily become displaced and lean at an undesired angle. Traditional solutions to these situations include inserting the umbrella pole further into the sand, flat surface, or configure a way to weigh the umbrella pole down. However, it is quickly discovered that these solutions have their limitations, whereby further insertion of the pole results in having the canopy closer to the sand or flat surface, and the pole often lacks weight bearing so structures configured to keep the pole stationary.

The present invention relates to a new and improved cooler that is configured for the reception of an umbrella. It resembles a traditional cooler, whereby the cooler includes an insulated interior compartment. The present invention facilitates the securement of an umbrella mask by utilizing the weight of the cooler in combination with a fastenable sleeve thereof to hold an umbrella proximal to a cooler.

### SUMMARY OF THE INVENTION

The invention disclosed herein provides an adjustable cooler mounted umbrella system, comprising an insulative container defining an internal cavity for reception of contents. The insulative container has an interior surface and an exterior surface. The exterior surface of said insulative container has at least one interface area, wherein each interface area defines an adjustable mount receiver with a plurality of horizontal recesses therein. The system also includes an umbrella mounting sleeve rotatably coupled to said mount receiver, wherein the umbrella mounting sleeve is configurable for adjustable angulation of an axis of reception of an umbrella shaft. The system also includes a threaded locking pin, wherein the threaded locking pin is configured to slide through an aperture in a flange formed on an external surface of the umbrella mounting sleeve and thread into an interior threaded surface of a horizontal recess of the plurality of horizontal recesses, thereby securing an angulation of the umbrella mounting sleeve relative to the mount receiver.

It is an object of the present invention to provide a system for securely containing an umbrella.

It is yet another object of the present invention is to provide a system that is attachable to a cooler and useable on both a sandy surface as well as a flat stiff surface.

The drawings and specific descriptions of the drawings, as well as any specific or alternative embodiments discussed, are intended to be read in conjunction with the entirety of this disclosure. The invention may be embodied in many different forms and should not be construed as being limited to the embodiments set forth herein; rather, these embodiments are provided by way of illustration only and so that this disclosure will be thorough, complete and fully convey understanding to those skilled in the art. The above and yet other objects and advantages of the present invention will become apparent from the hereinafter set forth Brief Description of the Drawings, Detailed Description of the Invention, and Claims appended herewith.

### BRIEF DESCRIPTION OF THE DRAWINGS

FIG. 1 illustrates an isometric view of the cooler system with umbrella mount.

FIG. 2 illustrates a top view of the cooler system with umbrella mount.

FIG. 3 illustrates a side view of the cooler system with umbrella mount.

FIG. 4 illustrates a front view of the cooler system with umbrella mount.

FIG. 5 illustrates an exploded isometric view of the cooler system with umbrella mount.

FIG. 6 illustrates a conceptual rear view of the cooler system with umbrella mount engaging with an umbrella.

FIG. 7 illustrates a front view of an umbrella mount receiver.

FIG. 8 illustrates a front view of an umbrella mount.

FIG. 9 illustrates a side view of the umbrella mount receiver of FIG. 7.

FIG. 10 illustrates a side view of the umbrella mount of FIG. 8.

FIG. 11 illustrates a conceptual side view of an umbrella with the umbrella mount affixed to a cooler from a rear view of the cooler system.

FIG. 12 illustrates a conceptual view of an umbrella engaged with the cooler system with umbrella mount.

FIG. 13 illustrates a top view of the umbrella mount with hinge mechanism.

FIG. 14 illustrates an isometric view of the umbrella mount with a hinged sleeve.

FIG. 15 illustrates an isometric view of the umbrella mount with hinged sleeve, as shown in FIG. 14 in an angulated orientation.

FIG. 16 illustrates an isometric view of the umbrella mount with hinged sleeve, as shown in FIG. 14 with both halves of the hinged sleeve open.

FIG. 17 illustrates an enlarged view of the umbrella mount and lower mount.

FIG. 18 illustrates an enlarged view of the lower mount.

FIG. 19 illustrates an enlarged view of the lower mount.

### DETAILED DESCRIPTION OF THE INVENTION

Outdoor events are commonplace. However, during warmer months of the year, people seek out shade to escape the heat of the sun. When visiting a beach or a park, people typically bring an umbrella with them. However, wind can rip an umbrella from its securement to the ground. Further, some areas, such as parking lots during a tailgating event do not work with a spiked end of an umbrella shaft because the ground is impermeable.

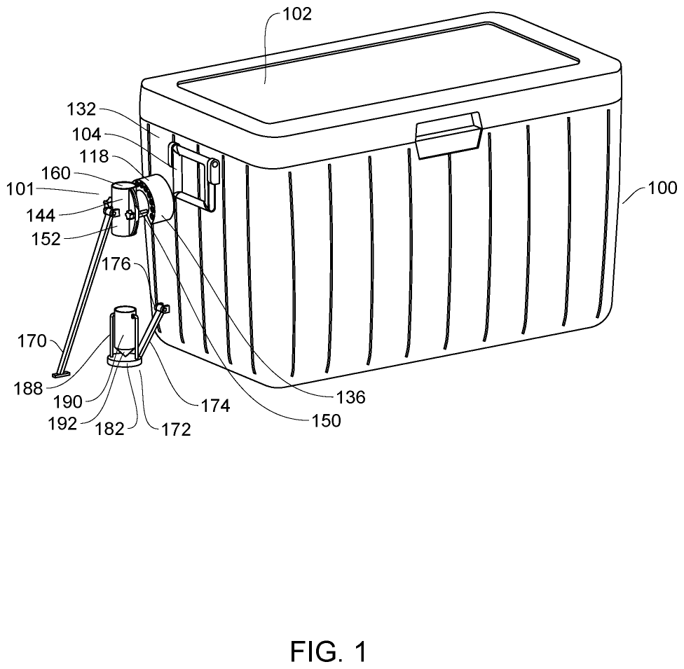

The invention herein provides a solution for these, and many other, problems that can arise. The invention includes a cooler 100 with an internal chamber 128 for contents like food and drinks. The food and drinks provide weight to help anchor a cooler 100. On the side of the cooler 100 is a securement system 101 for an umbrella. This system is particularly shown in FIGS. 1-19.

The system 101 incorporates a sleeve 144 which a user can insert the shaft 122 of an umbrella 120 through, which provides the primary form of securement. Pins 198 can be tightened to press against the umbrella shaft 122 to secure the shaft 122 to the sleeve 144. In addition to anchoring the cooler 100, the weight from the internal contents of a cooler 100 also helps keep the umbrella 120 anchored.

When used on a beach, or other permeable ground surface, the umbrella 120 can be angled in a variety of different orientations to maximize the available shade. In order to allow for adjustability of the umbrella 120 for different angulation, the sleeve 144 connects to a mount 118 on the exterior of the cooler 100 surface 132 that allows the sleeve 144 to rotate, which will thereby adjust the umbrella 120 to block out the sun in a wider range of angulation in the sky. The umbrella shaft 120 will fit through the sleeve 144, with the spike at the bottom penetrating the sand for additional anchoring.

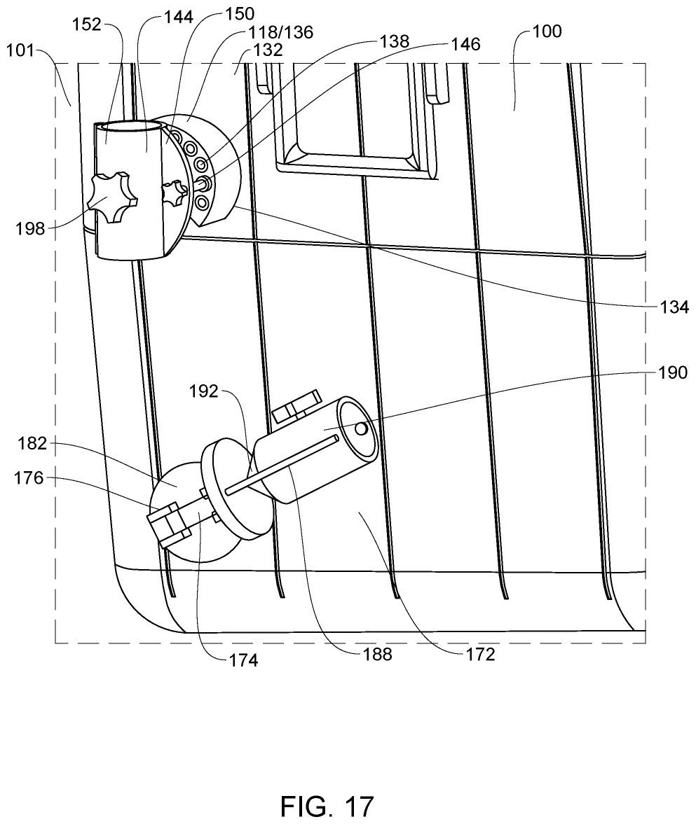

When used on an impermeable surface, like asphalt, a lower sleeve 172 can be used to provide securement of the lower portion of the umbrella shaft 122. The lower sleeve 190 rotates into position, aligning with the upper sleeve 144, and receives the umbrella shaft 122. The bottom platform 182 of the lower sleeve 190 rests on the ground to provide stability. However, the lower sleeve 190 is only used when the system is on firm ground. When used on a sandy surface, or similar, the lower sleeve 190 rotates out of the way, as shown in FIG. 17, so that the umbrella shaft 122 can bypass it.

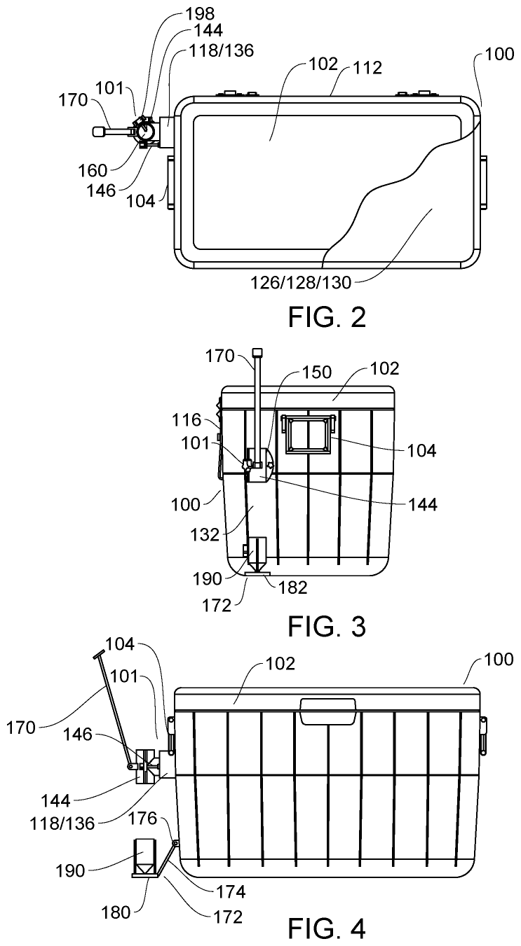

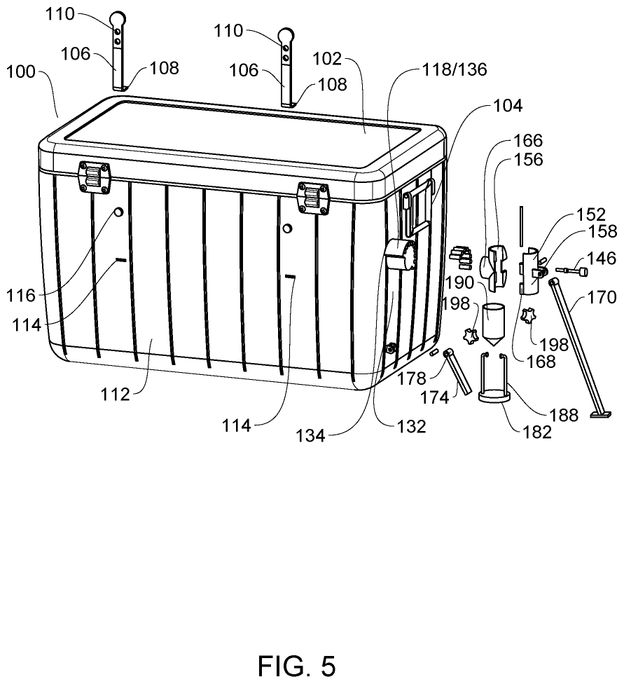

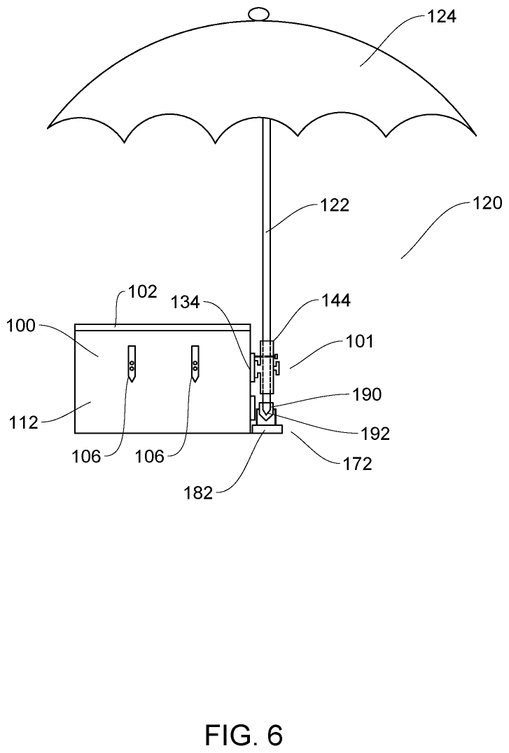

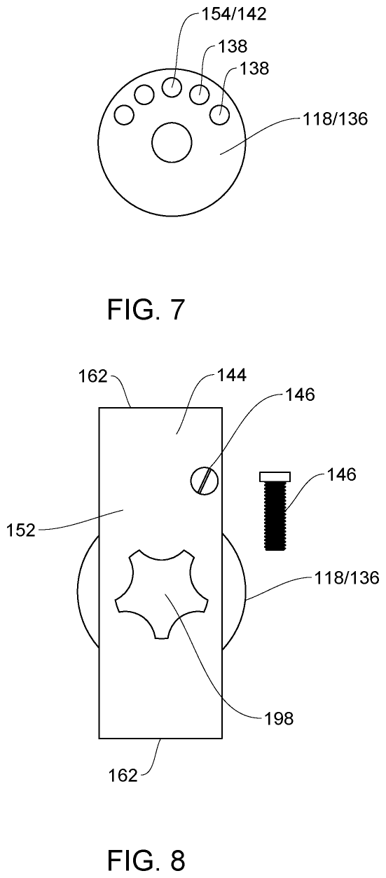

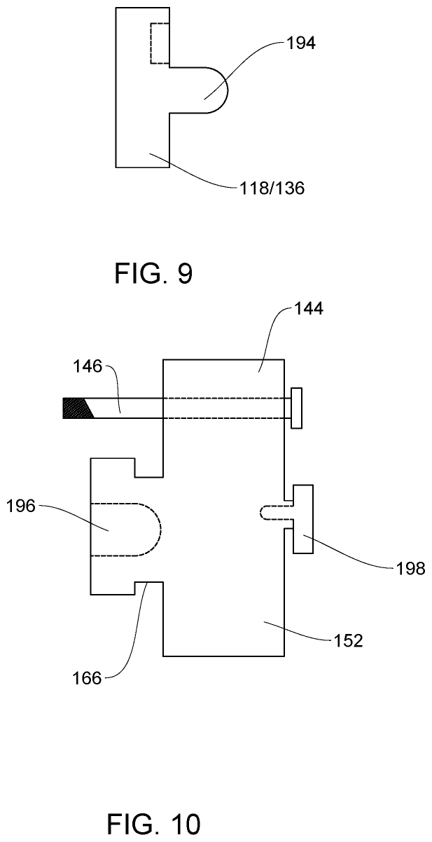

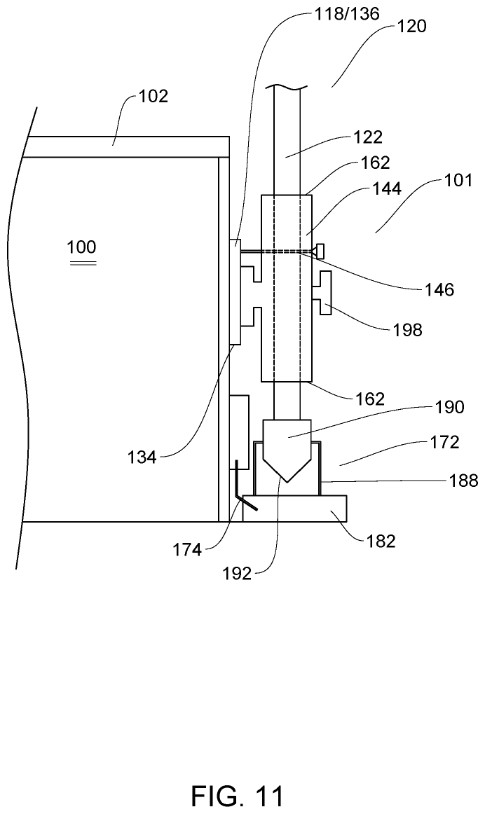

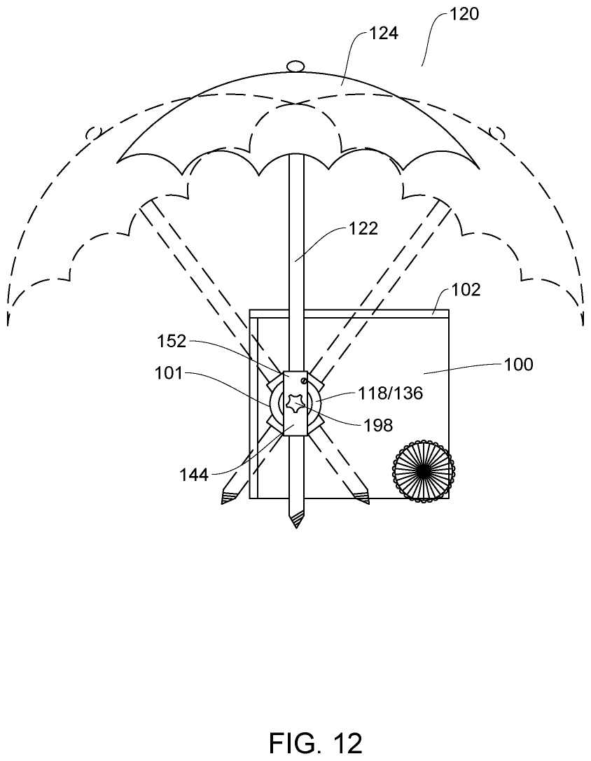

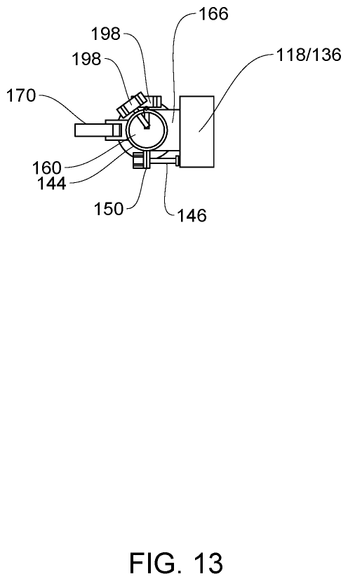

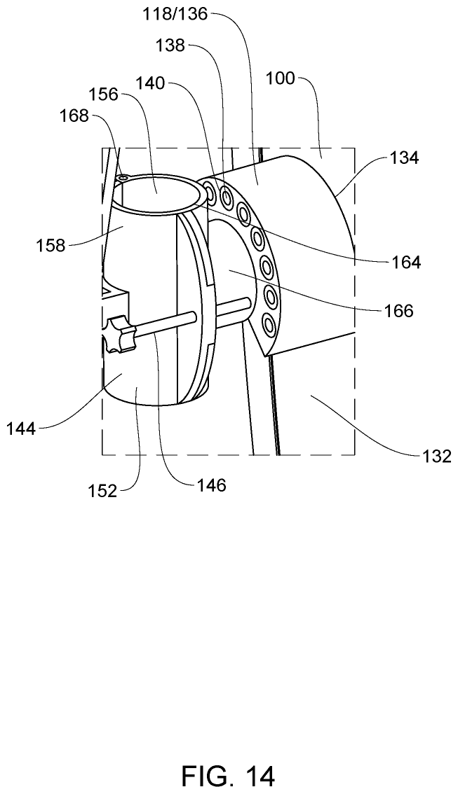

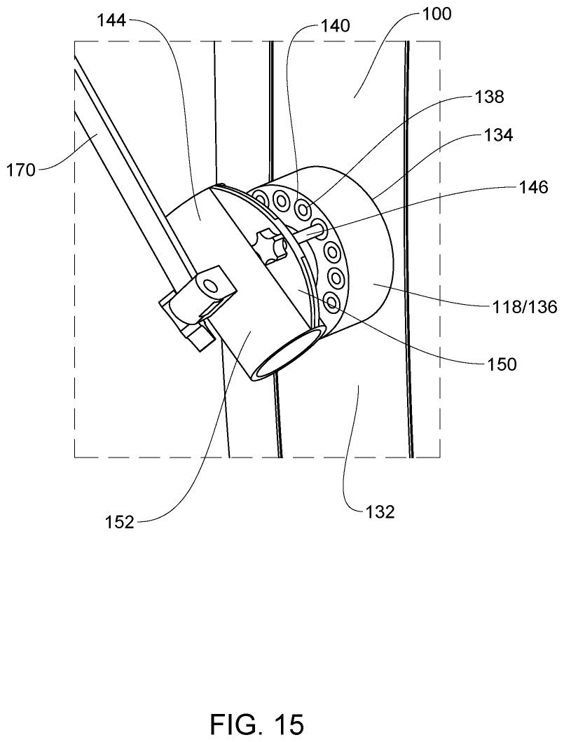

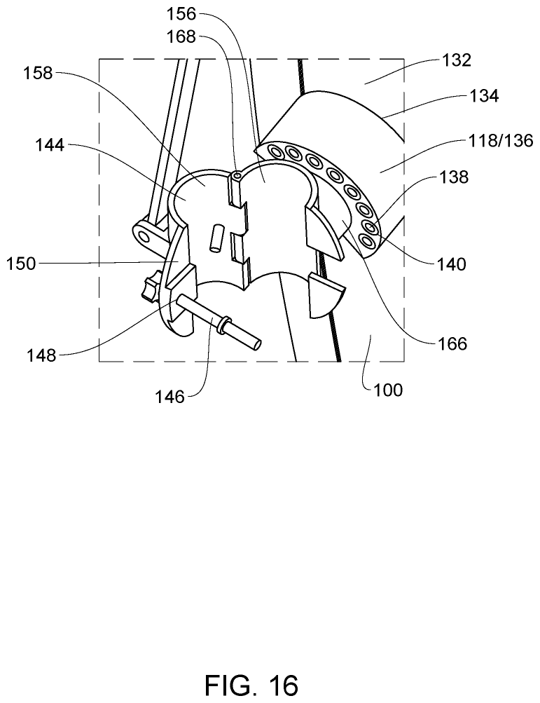

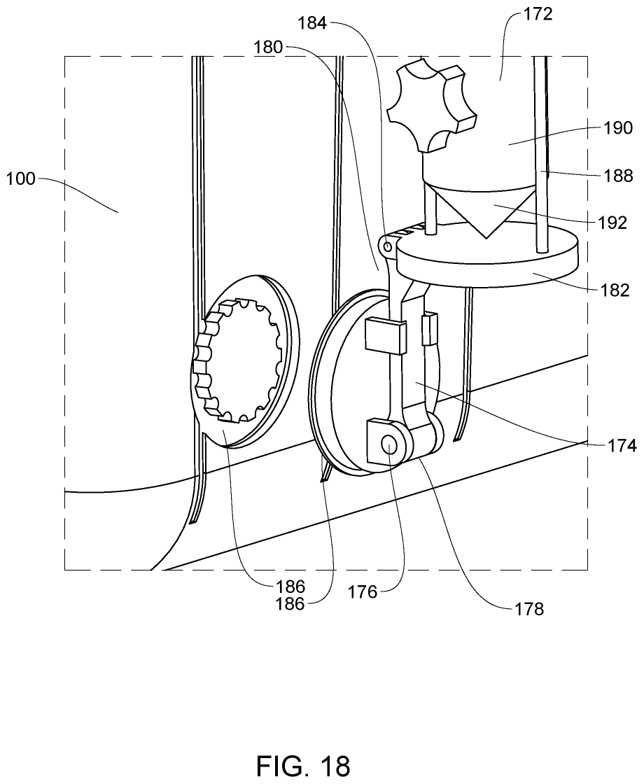

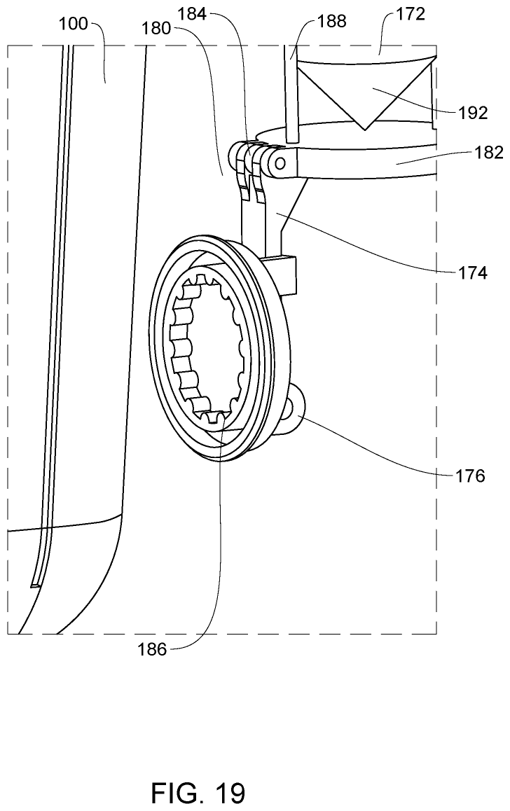

FIG. 1 illustrates an isometric view of the cooler 100 system with umbrella mount 118. FIG. 2 illustrates a top view of the cooler 100 system 101 with umbrella mount 118. FIG. 3 illustrates a side view of the cooler 100 system 101 with umbrella mount 118. FIG. 4 illustrates a front view of the cooler 100 system 101 with umbrella mount 118. FIG. 5 illustrates an exploded isometric view of the cooler 100 system 101 with umbrella mount 118. FIG. 6 illustrates a conceptual rear view of the cooler 100 system 101 with umbrella mount 118 engaging with an umbrella 120. FIG. 7 illustrates a front view of an umbrella mount receiver 136. FIG. 8 illustrates a front view of an umbrella mount 118. FIG. 9 illustrates a side view of the umbrella mount receiver 136 of FIG. 7. FIG. 10 illustrates a side view of the umbrella mount 118 of FIG. 8. FIG. 11 illustrates a conceptual side view of an umbrella 120 with the umbrella mount 118 affixed to a cooler 100 from a rear view of the cooler 100 system 101. FIG. 12 illustrates a conceptual view of an umbrella 120 engaged with the cooler 100 system 101 with umbrella mount 118. FIG. 13 illustrates a top view of the umbrella mount 118 with hinge mechanism 168. FIG. 14 illustrates an isometric view of the umbrella mount 118 with a sleeve 144 that is hinged. FIG. 15 illustrates an isometric view of the umbrella mount 118 with a sleeve 144 that is hinged, as shown in FIG. 14 in an angulated orientation. FIG. 16 illustrates an isometric view of the umbrella mount 118 with a sleeve 144 that is hinged, as shown in FIG. 14 with both halves 156/158 of the sleeve 144 that is hinged, in an open state. FIG. 17 illustrates an enlarged view of the umbrella mount 118 and lower mount 172. FIG. 18 illustrates an enlarged view of the lower mount 172. FIG. 19 illustrates an enlarged view of the lower mount 172.

In FIGS. 1-19 is shown an exemplary embodiment of the adjustable cooler mounted umbrella system 101. The system comprises an insulative container 100/126 defining an internal cavity 128 for reception of contents. The insulative container 100/126 has an interior surface 130 and an exterior surface 132. The exterior surface 132 of the insulative container 126 has at least one interface area 134, wherein each interface area 134 defines an adjustable mount receiver 136 with a plurality of horizontal recesses 138 therein. In some embodiments, each recess 138 includes an inner protective cylinder 140 having internal threading 142 for engagement with said locking pin 146 that is threaded. In some embodiments, the locking pin 146 is not threaded, as shown primarily in FIGS. 14-16.

In some embodiments, the mount receiver 136 is formed within the body of the exterior surface 132 of the insulative container 100/126, while in others, the mount receiver 136 is mounted to the body of the exterior surface 132 of the insulative container 100/126.

An umbrella mounting sleeve 144 is rotatably coupled to the mount receiver 136, wherein the umbrella mounting sleeve 144 is configurable for adjustable angulation of an axis of reception of an umbrella shaft 122. A locking pin 146 that is threaded is included in the system 101 to secure the sleeve 144 in an angle. The locking pin 146 is configured to slide through an aperture 148 in a flange 150 formed on an external surface 152 of said umbrella mounting sleeve 144 and thread into an interior threaded surface 154 of a horizontal recess 138 of said plurality of horizontal recesses 138, thereby securing an angulation of said umbrella mounting sleeve 144 relative to said mount receiver 136. In some embodiments, the mount receiver 136 includes a male rotational stub 194 that engages with a female rotational cavity 196 in said mounting shaft 166, as shown in FIGS. 9 and 10, whereby said engagement provides an axis of rotation for the mounting shaft 166.

In some embodiments, the umbrella mounting sleeve 144 is comprised of a two-part system having a first part 156 and a second part 158 that, when combined, form a sleeve 144 with an internal vertical cylindrical void 160 with two opposing open ends 162 capable of receiving an umbrella 120 shaft 122 within its inner circumference 164. The first part 156 of said two-part system forms a semicircular half of the internal vertical cylindrical void 160. The second part 158 of the two-part system forms an opposing semicircular half of said internal vertical cylindrical void 160. The first part 156 includes a mounting shaft 166 extending perpendicularly from an orientation of said internal vertical cylindrical void 160 for complemental engagement with the adjustable mount receiver 136. A hinge 168 pivotally couples the first half 156 to said second half 158. The second part 158 includes the flange 150 formed on said external surface 152 of said umbrella mounting sleeve 144.

In some embodiments of the system, the umbrella mounting sleeve 144 includes a pivotally connected support buttress 170. This helps support the sleeve 144 and pivots from an up position to a down position, as may be seen in FIGS. 1 and 4. Similar support buttresses may also be found on the lower sleeve portion.

In some embodiments the insulative container 100/126 further includes a lid 102, a pair of handles 104, and a pair of straps 106 connected to a back surface 112 of said cooler 100. The straps 106 may be used to secure an umbrella 120 during transport. When straps 106 are present, the cooler 100 includes at least a pair of recesses 114 in said back surface 112 of said cooler 100, and at least a pair of knobs 116 protruding from said back surface 112 of said cooler 100. Each strap 106 includes a lower engagement bracket 108, whereby the lower engagement bracket 108 is insertable into a recess 114 in said at least a pair of recesses 114 in said back surface 112 of said cooler 100. Each strap 106 also contains a flexible aperture 110. The flexible aperture 110 allows a knob 116 in said at least a pair of knobs 116 protruding from said back surface of said cooler 100 to pass through said flexible aperture 110, wherein said flexible aperture 110 is smaller in an unflexed circumference than a circumference of said knob 116 protruding from said back surface 112 of said cooler 100.

The system may also include an umbrella 120 having at least a shaft 122 and a canopy 124. The circumference of said shaft 122 of the umbrella 120 must be less than a circumference of an internal cylindrical void 164 of said umbrella mounting sleeve 144.

In some embodiments, the system includes an umbrella base mounting sleeve 172. The mounting sleeve 172 is coupled to the outer surface of the cooler by a hinged boom 174. The mounting sleeve 174 allows the base of the umbrella 120 to be secured when the cooler 100 is on a flat surface, like a parking lot. The hinged boom 174 pivotally connects to a rotatable outer surface engagement 186 at a proximal end 178 of said hinged boom 174 by a first hinge 176, as shown in FIGS. 17-19. The hinged boom 174 pivotally connecting to a platform 182 at a distal end 180 of said hinged boom 174 at a second hinge point 184. The platform 182 connects to said umbrella base mounting sleeve 172 by a pair of pillars 188 that position the umbrella base mounting sleeve 172 above the platform 182. The umbrella base mounting sleeve 172 includes a cylindrical sleeve 190 with a closed bottom 192 for containing a bottom of a shaft 122 of an umbrella 120.

When using the base mounting sleeve, the orientation of said cylindrical sleeve with a closed bottom of said umbrella base mounting sleeve is positioned below an opening of a cylindrical void of said umbrella mounting sleeve so that when a shaft of an umbrella is inserted through said umbrella mounting sleeve, the shaft of said umbrella may insert in to said cylindrical sleeve of said umbrella base mounting sleeve and terminate at said closed bottom, thereby containing said shaft of said umbrella.

While there has been shown and described above the preferred embodiment of the instant invention it is to be appreciated that the invention may be embodied otherwise than is herein specifically shown and described and that certain changes may be made in the form and arrangement of the parts without departing from the underlying ideas or principles of this invention as set forth in the Claims appended herewith.

I claim:

1. An adjustable cooler mounted umbrella system, comprising:
an insulative container defining an internal cavity for reception of contents;
said insulative container having an interior surface and an exterior surface;
said exterior surface of said insulative container having at least one interface area, wherein each of said at least one interface area defines an adjustable mount receiver with a plurality of horizontal recesses therein;
an umbrella mounting sleeve rotatably coupled to said mount receiver, wherein said umbrella mounting sleeve is configurable for adjustable angulation of an axis of reception of an umbrella shaft; and
a locking pin, wherein said locking pin is configured to slide through an aperture in a flange formed on an external surface of said umbrella mounting sleeve and into an interior surface of a horizontal recess of said plurality of horizontal recesses, thereby securing an angulation of said umbrella mounting sleeve relative to said mount receiver.

2. The adjustable cooler mounted umbrella system, as recited in claim 1, wherein the umbrella mounting sleeve comprises:
a two-part system having a first part and a second part that, when combined, form a sleeve with an internal vertical cylindrical void with two open ends capable of receiving an umbrella shaft within its inner circumference;
said first part of said two-part system forming a semicircular half of said internal vertical cylindrical void;
said second part of said two-part system forming an opposing semicircular half of said internal vertical cylindrical void;
said first part includes a mounting shaft extending perpendicularly from an orientation of said internal vertical cylindrical void for complemental engagement with said adjustable mount receiver;
a hinge pivotally coupling said first half to said second half; and
said second part including said flange formed on said external surface of said umbrella mounting sleeve.

3. The adjustable cooler mounted umbrella system, as recited in claim 2, wherein umbrella mounting sleeve includes a pivotally connected support buttress.

4. The adjustable cooler mounted umbrella system, as recited in claim 1, wherein the mount receiver is formed within the body of the exterior surface of the insulative container.

5. The adjustable cooler mounted umbrella system, as recited in claim 1, wherein the mount receiver is mounted to the body of the exterior surface of the insulative container.

6. The adjustable cooler mounted umbrella system, as recited in claim 1, wherein umbrella mounting sleeve includes a pivotally connected support buttress.

7. The adjustable cooler mounted umbrella system, as recited in claim 1, wherein the insulative container further includes a lid, a pair of handles, and a pair of straps connected to a back surface of said cooler.

8. The adjustable cooler mounted umbrella system, as recited in claim 7, wherein said cooler includes at least a pair of recesses in said back surface of said cooler, and at least a pair of knobs protruding from said back surface of said cooler.

9. The adjustable cooler mounted umbrella system, as recited in claim 8, wherein each strap in said pair of straps includes:
a lower engagement bracket, whereby said lower engagement bracket is insertable into a recess in said at least a pair of recesses in said back surface of said cooler; and
a flexible aperture, whereby said flexible aperture allows a knob in said at least a pair of knobs protruding from said back surface of said cooler to pass through said flexible aperture, wherein said flexible aperture is smaller in an unflexed circumference than a circumference of said knob protruding from said back surface of said cooler.

10. The adjustable cooler mounted umbrella system, as recited in claim 1, further comprising:
an umbrella having at least a shaft and a canopy, wherein a circumference of said shaft is less than a circumference of an internal cylindrical void of said umbrella mounting sleeve.

11. The adjustable cooler mounted umbrella system, as recited in claim 1, wherein each recess in said plurality of horizontal recesses includes an inner protective cylinder having internal threading for engagement with said locking pin, wherein said locking pin includes threading.

12. The adjustable cooler mounted umbrella system, as recited in claim 1, further comprising:
an umbrella base mounting sleeve coupled to said outer surface of said cooler by a hinged boom;
said hinged boom pivotally connecting to a rotatable outer surface engagement at a proximal end of said hinged boom by a first hinge;
said hinged boom pivotally connecting to a platform at a distal end of said hinged boom at a second hinge;
said platform connecting to said umbrella base mounting sleeve by a pair of pillars that position the umbrella base mounting sleeve above the platform; and
said umbrella base mounting sleeve includes a cylindrical sleeve with a closed bottom for containing a bottom of a shaft of an umbrella.

13. The adjustable cooler mounted umbrella system, as recited in claim 12, wherein an orientation of said cylindrical sleeve with a closed bottom of said umbrella base mounting sleeve is positioned below an opening of a cylindrical void of said umbrella mounting sleeve so that when a shaft of an umbrella is inserted through said umbrella mounting sleeve, the shaft of said umbrella may insert in to said cylindrical sleeve of said umbrella base mounting sleeve and terminate at said closed bottom, thereby containing said shaft of said umbrella.
